(19) United States
(12) Patent Application Publication
(10) Pub. No.: US 2026/0094111 A1
(43) Pub. Date: Apr. 2, 2026

(54) WORK MACHINE, AND PORTABLE TERMINAL DEVICE FOR WORK MACHINE

(71) Applicant: SUMITOMO CONSTRUCTION MACHINERY CO., LTD., Tokyo (JP)

(72) Inventor: Takashi NISHI, Chiba (JP)

(21) Appl. No.: 19/339,989

(22) Filed: Sep. 25, 2025

(30) Foreign Application Priority Data
Sep. 30, 2024 (JP) 2024-171366

(51) Int. Cl. G06Q 10/0833; E02F 3/32; E02F 9/22; G07C 5/00; G07C 5/02; H04W 76/14

(52) U.S. Cl. CPC G06Q 10/0833; E02F 3/32; G07C 5/008; G07C 5/02; E02F 9/2203; E02F 9/2285; E02F 9/2292; E02F 9/2296; H04W 76/14

(57) ABSTRACT

A work machine includes a lower traveling body; an upper slewing body that is slewably mounted on the lower traveling body; an attachment that is attached to the upper slewing body; an information acquisition device including circuitry configured to acquire payload information that is information of a weight of an object loaded by the attachment on a bed of a delivery vehicle; and a communication device including circuitry configured to transmit the payload information to a portable terminal device configured to enable wireless communication with the delivery vehicle.

### CROSS-REFERENCE TO RELATED APPLICATIONS

This application is based upon and claims priority to Japanese Patent Application No. 2024-171366, filed on Sep. 30, 2024, the entire contents of which are incorporated herein by reference.

### BACKGROUND

### 1. Technical Field

The present disclosure relates to a work machine, and a portable terminal device for the work machine.

### 2. Description of Related Art

A known excavator includes a display device configured to display payload information that is information of the weight of an object loaded on the bed of a delivery vehicle, such as a dump truck or the like.

Such an excavator may include, in a cab, a printer configured to print payload information. This is for enabling an operator of the excavator to hand over, to a driver of the delivery vehicle, a paper sheet (slip) on which the payload information is printed. However, this way is not efficient because it requires time and effort to print and hand over the slip.

### SUMMARY

A work machine according to an embodiment of the present disclosure includes: a lower traveling body; an upper slewing body that is slewably mounted on the lower traveling body; an attachment that is attached to the upper slewing body; an information acquisition device including circuitry configured to acquire payload information that is information of a weight of an object loaded by the attachment on a bed of a delivery vehicle; and a communication device including circuitry configured to transmit the payload information to a portable terminal device configured to enable wireless communication with the delivery vehicle.

### BRIEF DESCRIPTION OF THE DRAWINGS

FIG. 1 is a schematic diagram illustrating a configuration example of a management system for a work machine according to an embodiment of the present disclosure;

FIG. 2 is a side diagram of the work machine illustrated in FIG. 1;

FIG. 3 is a diagram illustrating a configuration example of a drive control system for the work machine illustrated in FIG. 2;

FIG. 4 is a block diagram illustrating a configuration example of a payload information management system;

FIG. 5 is a flow diagram illustrating an example of a flow of payload information;

FIG. 6 is a diagram illustrating a configuration example of an image display part and an operation part of a display device;

FIG. 7 is a diagram illustrating a display example of a screen displayed on the image display part;

FIG. 8 is a diagram illustrating a display example of a screen displayed on a display part of an operator portable terminal device;

FIG. 9 is a diagram illustrating another display example of the screen displayed on the display part of the operator portable terminal device;

FIG. 10 is a diagram illustrating a display example of a screen displayed on a display part of a driver portable terminal device; and

FIG. 11 is a diagram illustrating yet another display example of the screen displayed on the display part of the operator portable terminal device.

### DETAILED DESCRIPTION

It is desirable to reduce such time and effort for delivery of the payload information from the operator of the work machine, such as an excavator or the like, to the driver of the delivery vehicle.

Hereinafter, embodiments of the present disclosure will be described with reference to the drawings. The embodiments as described below do not limit the present disclosure but are illustrative. All of the features described in the embodiments and combinations of the features are not necessarily essential to the present disclosure. Throughout the drawings, the same or corresponding components are denoted by the same or corresponding symbols, and description may be omitted.

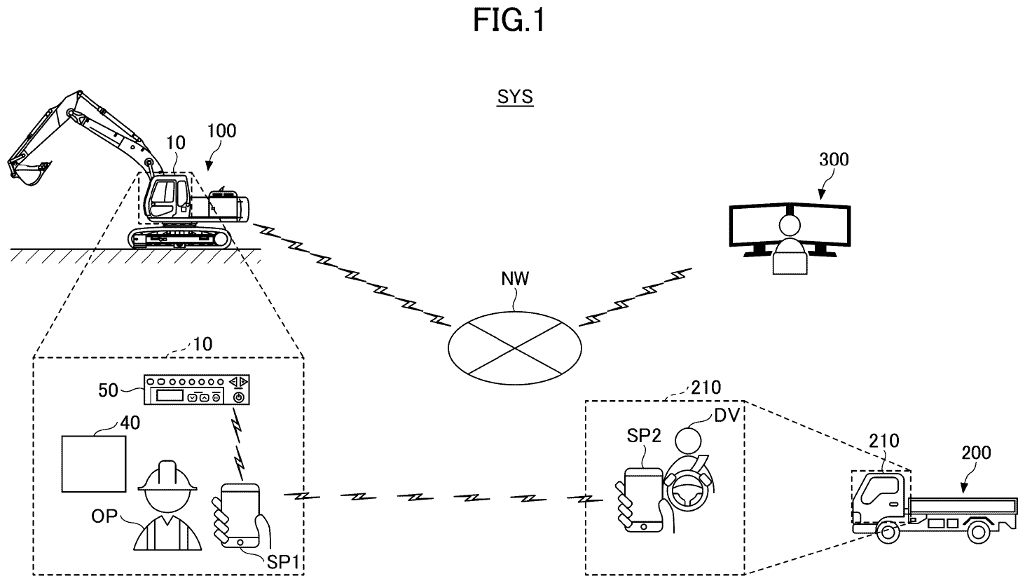

First, an overview of a management system SYS for a work machine according to an embodiment of the present disclosure will be described with reference to FIG. 1. FIG. 1 is a schematic diagram illustrating a configuration example of the management system SYS.

As illustrated in FIG. 1, the management system SYS includes a work machine 100, a delivery vehicle 200, and a management center 300. The work machine 100 and the management center 300 are connected to each other to enable data transmission and reception via a communication line NW. In the illustrated example, the work machine 100 is configured to enable data transmission to and data reception from the management center 300 via the communication line NW.

Specifically, for example, the work machine 100 can transmit, to the management center 300, payload information that is information of the weight of an object loaded on the bed of the delivery vehicle 200, such as a dump truck or the like. In the illustrated example, the payload information is acquired (generated) based on an output of an information acquisition device IAD that is attached to the work machine 100. Thus, a manager located in the management center 300 can confirm the content of the payload information from the work machine 100. The information acquisition device IAD, configured to acquire the payload information, is not only a device attached to the work machine 100, but also may be, for example: a device attached to a flying object configured to fly above a work site, such as a drone or the like; a device installed in the work site, such as a fixed-point camera or the like; or a photographing device configured to be carried by a worker located in the work site. Note that the information acquisition device IAD is an example of the information acquisition device included in the work machine of the present disclosure. The information acquisition device included in the work machine of the present disclosure is an electronic circuit or circuitry (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit for specific applications.

The management system SYS may include the single work machine 100 or a plurality of the work machines 100. Thus, the management system SYS can manage the payload information of each of the plurality of the work machines 100. The management system SYS may include the single management center 300 or a plurality of the management centers 300.

Also, in the present embodiment, the work machine 100 includes a cab 10 serving as an operating room, and a wireless communication device 50 and a display device 40 are provided in the cab 10. The wireless communication device 50 is configured to communicate with an operator portable terminal device SP1, such as a smartphone or the like, which is carried by an operator OP sitting on an operating seat provided in the cab 10. In the illustrated example, communication between the wireless communication device 50 and the operator portable terminal device SP1 is realized through direct wireless communication. The “direct wireless communication” between the wireless communication device 50 and the operator portable terminal device SP1 is wireless communication performed directly between the wireless communication device 50 and the operator portable terminal device SP1 without a base station, such as a communication satellite, a ground base station, or the like. However, the “direct wireless communication” between the wireless communication device 50 and the operator portable terminal device SP1 includes wireless communication performed via a repeater provided between the wireless communication device 50 and the operator portable terminal device SP1. The same applies to the direct wireless communication between the operator portable terminal device SP1 and a driver portable terminal device SP2. The communication between the wireless communication device 50 and the operator portable terminal device SP1 may also be realized through wired communication. In this case, the operator portable terminal device SP1 may be held by a holding member, such as a cradle or the like, provided in the cab 10. Also, the display device 40 is provided at a position that can be seen by the operator OP sitting on the operating seat provided in the cab 10. Note that the wireless communication device 50 is an example of the communication device included in the work machine of the present disclosure. The communication device included in the work machine of the present disclosure is an electronic circuit or circuitry (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit for specific applications.

Also, in the present embodiment, the cab 10 is configured to enable the direct wireless communication of the operator portable terminal device SP1 with the driver portable terminal device SP2, such as, for example, a smartphone carried by a driver DV sitting on a driver's seat provided in a driving room 210 of the delivery vehicle 200. The operator portable terminal device SP1 may be configured to perform the direct wireless communication with an on-board terminal device mounted in the delivery vehicle 200.

In this case, the on-board terminal device may be configured to perform the direct wireless communication or wired communication with the driver portable terminal device SP2. Also, the driver portable terminal device SP2 may be configured to perform the direct wireless communication with the wireless communication device 50.

In the illustrated example, the wireless communication device 50 is configured to perform exchange of information between the wireless communication device 50 and the operator portable terminal device SP1 via Bluetooth (registered trademark). However, the wireless communication device 50 may be configured to perform exchange of information between the wireless communication device 50 and the operator portable terminal device SP1 via a wireless local area network (LAN), such as Wi-Fi (registered trademark) or the like. Also, the wireless communication device 50 may be configured to perform the wired communication between the wireless communication device 50 and the operator portable terminal device SP1.

Also, in the illustrated example, the direct wireless communication performed between the operator portable terminal device SP1 and the driver portable terminal device SP2 is realized using Bluetooth (registered trademark). Specifically, this direct wireless communication is established without pairing. “Pairing” is an example of a preliminary operation for establishing the direct wireless communication, and refers to an operation for permitting communication between a pair of devices adapted for Bluetooth (registered trademark). For example, when the operator portable terminal device SP1 and the driver portable terminal device SP2 are both iPhones (registered trademark), this direct wireless communication is realized using AirDrop (registered trademark), which is data sharing software. Alternatively, when the operator portable terminal device SP1 and the driver portable terminal device SP2 are both smartphones in which Android (registered trademark) is installed, this direct wireless communication is realized using Quick Share, which is data sharing software.

However, the direct wireless communication between the operator portable terminal device SP1 and the driver portable terminal device SP2 may be established by performing a preliminary operation, such as pairing or the like. In this case, this direct wireless communication may be realized using Wi-Fi (registered trademark). Also, the wireless communication between the operator portable terminal device SP1 and the driver portable terminal device SP2 may be realized using a portable phone communication network, a satellite communication network, or the like. In this case, exchange of payload information between the operator portable terminal device SP1 and the driver portable terminal device SP2 may be realized using email.

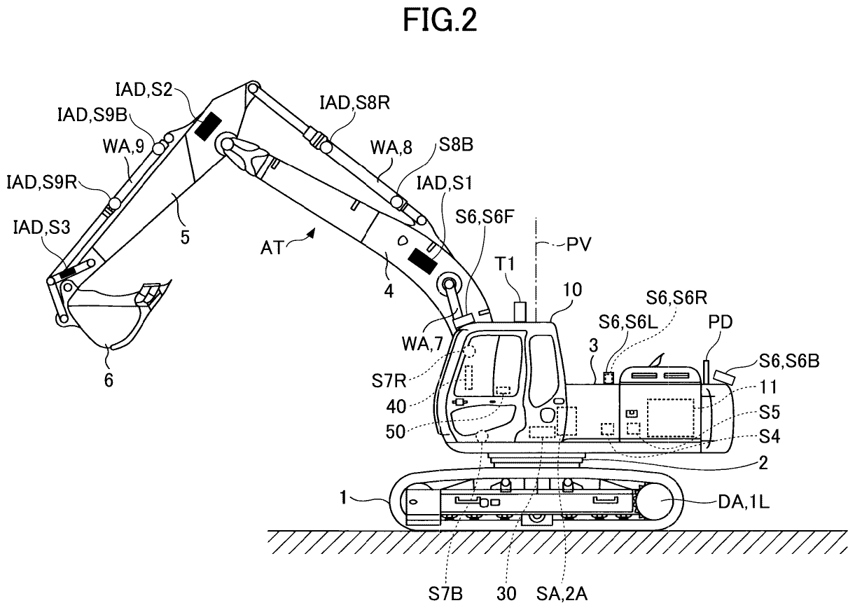

Next, the work machine 100 will be described in detail with reference to FIG. 2. FIG. 2 is a side diagram of an excavator (shovel) that is an example of the work machine 100. The work machine 100 may be a crane or a forklift. In the illustrated example, an upper slewing body 3 is slewably mounted on a lower traveling body 1 of the work machine 100 via a slewing mechanism 2. A boom 4 is attached to the upper slewing body 3, an arm 5 is attached to the tip of the boom 4, and a bucket 6 serving as an end attachment is attached to the tip of the arm 5. The end attachment may be a breaker, a grapple, or the like.

The boom 4, the arm 5, and the bucket 6 form an excavating attachment, which is an example of an attachment AT. The boom 4, the arm 5, and the bucket 6 are driven by a boom cylinder 7, an arm cylinder 8, and a bucket cylinder 9, which are each a hydraulic cylinder that is an example of a working actuator WA. A boom angle sensor S1 is attached to the boom 4, an arm angle sensor S2 is attached to the arm 5, and a bucket angle sensor S3 is attached to the bucket 6.

The boom angle sensor S1 is configured to detect a rotation angle of the boom 4. In the present embodiment, the boom angle sensor S1 is an acceleration sensor, and can detect a boom angle that is the rotation angle of the boom 4 with respect to the upper slewing body 3. The boom angle is, for example, the minimum angle when the boom 4 is moved down to the lowest position, and the boom angle increases as the boom 4 is raised.

The arm angle sensor S2 is configured to detect a rotation angle of the arm 5. In the present embodiment, the arm angle sensor S2 is an acceleration sensor, and can detect an arm angle that is the rotation angle of the arm 5 with respect to the boom 4. The arm angle is, for example, the minimum angle when the arm 5 is closed at most, and the arm angle increases as the arm 5 is opened.

The bucket angle sensor S3 is configured to detect a rotation angle of the bucket 6. In the present embodiment, the bucket angle sensor S3 is an acceleration sensor, and can detect a bucket angle that is the rotation angle of the bucket 6 with respect to the arm 5. The bucket angle is, for example, the minimum angle when the bucket 6 is closed at most, and the bucket angle increases as the bucket 6 is opened.

The boom angle sensor S1, the arm angle sensor S2, and the bucket angle sensor S3 may each be, for example, a potentiometer using a variable resistor, a stroke sensor that detects a stroke amount of a corresponding hydraulic cylinder, or a rotary encoder that detects the rotation angle about a coupling pin. The boom angle sensor S1, the arm angle sensor S2, and the bucket angle sensor S3 form a posture sensor AS configured to detect a posture of the excavating attachment.

A boom bottom pressure sensor S7B is a pressure sensor configured to detect a boom bottom pressure, which is a pressure of hydraulic oil in the bottom-side oil chamber of the boom cylinder 7. A boom rod pressure sensor S7R is a pressure sensor configured to detect a boom rod pressure, which is a pressure of hydraulic oil in a rod-side oil chamber of the boom cylinder 7. An arm bottom pressure sensor S8B is a pressure sensor configured to detect an arm bottom pressure, which is a pressure of hydraulic oil in a bottom-side oil chamber of the arm cylinder 8. An arm rod pressure sensor S8R is a pressure sensor configured to detect an arm rod pressure, which is a pressure of hydraulic oil in a rod-side oil chamber of the arm cylinder 8. A bucket bottom pressure sensor S9B is a pressure sensor configured to detect a bucket bottom pressure, which is a pressure of hydraulic oil in a bottom-side oil chamber of the bucket cylinder 9. A bucket rod pressure sensor S9R is a pressure sensor configured to detect a bucket rod pressure, which is a pressure of hydraulic oil in a rod-side oil chamber of the bucket cylinder 9. In the illustrated example, the boom bottom pressure sensor S7B is provided in an oil path connecting the bottom-side oil chamber of the boom cylinder 7 and a control valve unit 17, but may be provided in the boom cylinder 7. The same applies to the boom rod pressure sensor S7R, the arm bottom pressure sensor S8B, the arm rod pressure sensor S8R, the bucket bottom pressure sensor S9B, and the bucket rod pressure sensor S9R.

The upper slewing body 3 includes the cab 10, an engine 11, a positioning device PD, a machine body tilt sensor S4, a slewing angle velocity sensor S5, a space recognition device S6, a slewing actuator SA, a communication device T1, and the like.

The cab 10 includes an excavator controller 30 and the wireless communication device 50. Also, the cab 10 includes the operating seat, an operation device 26, a display device 40, and the like. The excavator controller 30 is a control device configured to execute various calculations. The excavator controller 30 is provided, for example, in the cab 10, and is configured to perform drive control of the work machine 100. The functions of the excavator controller 30 may be realized by hardware, software, or a combination of hardware and software. For example, the excavator controller 30 is formed by a microcomputer including: a central processing unit (CPU); a memory (volatile storage device), such as a random access memory (RAM) or the like; a nonvolatile storage device, such as a read only memory (ROM) or the like; and an interface device for various inputs and outputs. The excavator controller 30 may realize various functions, for example, by executing, on the CPU, various programs installed in the nonvolatile storage device.

The engine 11 is an example of a drive source of the work machine 100. In the illustrated example, the engine 11 is a diesel engine, and is mounted at the rear of the upper slewing body 3. An output shaft of the engine 11 is connected to input shafts of a main pump 14 and a pilot pump 15. Specifically, the engine 11 rotates at a predetermined target rotation speed under direct or indirect control by the excavator controller 30, thereby driving the main pump 14, the pilot pump 15, and the like. The drive source of the work machine 100 may be a battery-driven electric motor. That is, the work machine 100 may be a hybrid work machine or may be an electric work machine.

The machine body tilt sensor S4 is configured to detect a tilt of the upper slewing body 3 relative to a predetermined plane. In the illustrated example, the machine body tilt sensor S4 is an acceleration sensor configured to detect tilt angles of the upper slewing body 3 relative to a horizontal plane about a front-rear axis and a right-left axis. The front-rear axis and the right-left axis of the upper slewing body 3 are, for example, orthogonal to each other to pass through a center point that is a point on a slewing axis PV of the work machine 100.

The slewing angle velocity sensor S5 is configured to detect a slewing angle velocity of the upper slewing body 3. In the present embodiment, the slewing angle velocity sensor S5 is a gyro sensor. The slewing angle velocity sensor S5 may be a resolver, a rotary encoder, or the like. Also, the slewing angle velocity sensor S5 may be configured to detect a slewing velocity. Also, the slewing velocity may be calculated from the slewing angle velocity.

The space recognition device S6 is configured to acquire an image of the surroundings of the work machine 100. In the illustrated example, the space recognition device S6 includes a front camera S6F configured to photograph a space in front of the work machine 100, a left camera S6L configured to photograph a space leftward of the work machine 100, a right camera S6R configured to photograph a space rightward of the work machine 100, and a rear camera S6B configured to photograph a space rearward of the work machine 100.

The space recognition device S6 is, for example, a monocular camera having a photographing element, such as a CCD, a CMOS, or the like, and may output a photographed image to the display device 40.

The front camera S6F is attached, for example, to the roof of the cab 10. The left camera S6L is attached to a left end of the upper surface of the upper slewing body 3. The right camera S6R is attached to a right end of the upper surface of the upper slewing body 3. The rear camera S6B is attached to a rear end of the upper surface of the upper slewing body 3.

The space recognition device S6 provided at the above-described position can photograph an object existing around the work machine 100. The space recognition device S6 may be a camera (e.g., an RGBD camera or a stereo camera) configured to recognize a distance up to an object to be photographed. The space recognition device S6 may be a LiDAR sensor.

The positioning device PD is configured to acquire information of the position of the work machine 100. In the present embodiment, the positioning device PD is configured to measure the position and the orientation of the work machine 100. Specifically, the positioning device PD is a global navigation satellite system (GNSS) receiver including an electronic compass, and is configured to measure the latitude, the longitude, and the altitude of the current position of the work machine 100, and measure the orientation of the work machine 100 (the upper slewing body 3). In the illustrated example, a reference coordinate system is the world geodetic system. The world geodetic system is a three-dimensional orthogonal XYZ coordinate system in which the origin is set at the center of gravity of the globe, an X axis is taken in a direction toward the intersection between the Greenwich meridian and the equator, a Y axis is taken in a direction at 90 degrees of the east longitude, and a Z axis is taken in a direction toward the North Pole.

The communication device T1 is configured to control communication with a device outside the work machine 100. In the present embodiment, the communication device T1 is configured to control communication between the communication device T1 and the device outside the work machine 100 via a wireless communication network. The communication device T1 may include, for example, a mobile communication module responding to a mobile communication standard (e.g., LTE (Long Term Evolution), 4G (4th Generation), or 5G (5th Generation)), or a satellite communication module for connecting to the satellite communication network.

Also, the communication device T1 may be configured, for example, to control wireless communication between an external GNSS survey system and the work machine 100.

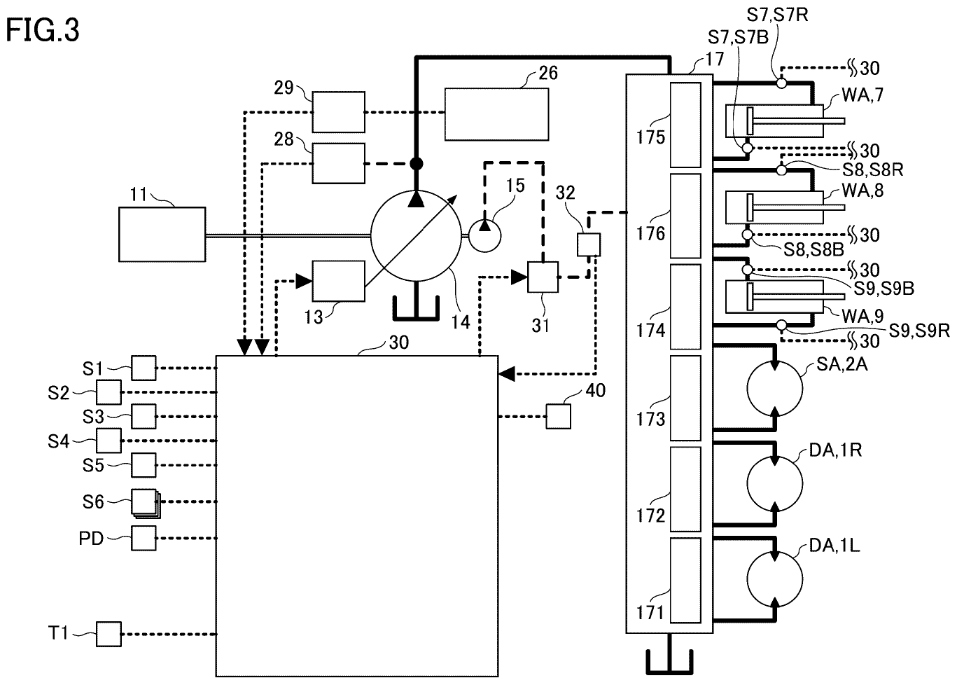

FIG. 3 is a diagram illustrating a configuration example of a drive control system for the work machine 100 illustrated in FIG. 2. In FIG. 3, a mechanical power transmission system is indicated by a double line, a hydraulic oil line is indicated by a thick solid line, a pilot line is indicated by a broken line, and an electric drive/control system is indicated by a dotted line.

A drive system of the work machine 100 according to the present embodiment includes the engine 11, a regulator 13, the main pump 14, and the control valve unit 17. A hydraulic drive system of the work machine 100 includes traveling hydraulic motors (a left traveling hydraulic motor 1L and a right traveling hydraulic motor 1R) serving as a drive actuator DA, a slewing hydraulic motor 2A serving as a slewing actuator SA, and the boom cylinder 7, the arm cylinder 8, and the bucket cylinder 9 each serving as the working actuator WA.

The regulator 13 is configured to control the discharge amount of the main pump 14. In the illustrated example, the regulator 13 adjusts the angle (tilt angle) of a swashplate of the main pump 14 in accordance with a control command from the excavator controller 30.

Similar to the engine 11, the main pump 14 is mounted in the upper slewing body 3, and supplies hydraulic oil to the control valve unit 17 through the hydraulic oil line. The main pump 14 is driven by the engine 11. In the illustrated example, the main pump 14 is a variable displacement hydraulic pump. When the tilt angle of the swashplate is adjusted by the regulator 13 under control by the excavator controller 30, the stroke length of a piston is adjusted and the discharge flow rate (discharge pressure) is controlled.

The control valve unit 17 is a hydraulic control device configured to control a hydraulic system in the work machine 100. In the illustrated example, the control valve unit 17 includes control valves 171 to 176 as spool valves. The control valve unit 17 is configured to selectively supply hydraulic oil discharged by the main pump 14 to one or more hydraulic actuators through the control valves 171 to 176. The control valves 171 to 176 control, for example, the flow rate of hydraulic oil flowing from the main pump 14 to the hydraulic actuators and the flow rate of hydraulic oil flowing from the hydraulic actuators to a hydraulic oil tank. The hydraulic actuators include the boom cylinder 7, the arm cylinder 8, the bucket cylinder 9, the left traveling hydraulic motor 1L, the right traveling hydraulic motor 1R, and the slewing hydraulic motor 2A. Specifically, the control valve 171 corresponds to the left traveling hydraulic motor 1L, the control valve 172 corresponds to the right traveling hydraulic motor 1R, and the control valve 173 corresponds to the slewing hydraulic motor 2A. Also, the control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to a hydraulic control device through a pilot line. In the present embodiment, the pilot pump 15 is a fixed displacement hydraulic pump. However, the pilot pressure generating device may be realized by the main pump 14. That is, the main pump 14 may have a function of supplying hydraulic oil to various hydraulic control devices through a pilot line, in addition to the function of supplying hydraulic oil to the control valve unit 17 through the hydraulic oil line. In this case, provision of the pilot pump 15 may be omitted.

The operation device 26 is a device used by the operator OP in the cab 10 to operate an actuator. The actuator includes at least one of a hydraulic actuator or an electric actuator. In the illustrated example, the operation device 26 includes an operation lever, a travelling lever, and a travelling pedal. The operation lever includes a left operation lever for a slewing operation and an arm operation, and a right operation lever for a boom operation and a bucket operation.

A discharge pressure sensor 28 is configured to detect the discharge pressure of the main pump 14. In the present embodiment, the discharge pressure sensor 28 outputs the detected value to the excavator controller 30.

An operation sensor 29 is configured to detect operation content of the operator OP using the operation device 26. In the present embodiment, the operation sensor 29 detects an operation direction and an operation amount of the operation device 26 corresponding to each of the actuators, and outputs the detected values to the excavator controller 30. Specifically, the operation sensor 29 is, for example, a tilt sensor configured to detect a tilt angle of the operation lever, or an angle sensor configured to detect a pivot angle of the operation lever around the pivot axis. The operation sensor 29 may include another sensor, such as a pressure sensor, a current sensor, a voltage sensor, a distance sensor, or the like. In the illustrated example, the excavator controller 30 controls an opening area of an electromagnetic valve 31 in accordance with the output of the operation sensor 29. The excavator controller 30 applies a pressure of hydraulic oil discharged by the pilot pump 15 to pilot ports of corresponding control valves in the control valve unit 17. The pressure (pilot pressure) of hydraulic oil applied to each of the pilot ports is, in principle, a pressure in accordance with the direction and the amount of the operation of the operation device 26 corresponding to each of the hydraulic actuators. In this manner, the operation device 26 is configured to apply the pressure of hydraulic oil discharged by the pilot pump 15 to the pilot ports of the corresponding control valves in the control valve unit 17.

The electromagnetic valve 31, which functions as a control valve for machine control, is disposed in an oil path connecting the pilot pump 15 and the pilot port of the control valve in the control valve unit 17, and is configured to change the flow path area of the oil path. In the illustrated example, the electromagnetic valve 31 operates in accordance with a control command output by the excavator controller 30. Therefore, the excavator controller 30 can apply the pressure of hydraulic oil discharged by the pilot pump 15 to the pilot port of the control valve in the control valve unit 17 through the electromagnetic valve 31 independently of the operation of the operation device 26 by the operator OP, thereby realizing a desired pilot pressure. In the illustrated example, the excavator controller 30 is configured to feedback-control the pilot pressure based on an output of a pilot pressure sensor 32.

With this configuration, not only when the specific operation device 26 is operated but also when the specific operation device 26 is not operated, the excavator controller 30 can operate the hydraulic actuator corresponding to that specific operation device 26.

Also, the excavator controller 30 is configured to perform various functions other than the function of controlling the pilot pressure. For example, the excavator controller 30 can set a target rotation speed based on a working mode or the like that is previously set by a predetermined operation of the operator OP or the like, thereby performing drive control to rotate the engine 11 at a constant speed.

Also, the excavator controller 30 can output a control command to the regulator 13, if necessary, to change the discharge amount of the main pump 14.

Also, the excavator controller 30 can perform, for example, control of a machine guidance function for guiding the operator OP manually operating the work machine 100 through the operation device 26. Also, the excavator controller 30 can perform, for example, control of a machine control function for automatically supporting the operator OP manually operating the work machine 100 through the operation device 26.

Also, the excavator controller 30 can acquire payload information based on the output of the information acquisition device IAD. In the illustrated example, the information acquisition device IAD includes a posture sensor AS and a cylinder pressure sensor CPS. The posture sensor AS includes the boom angle sensor S1, the arm angle sensor S2, and the bucket angle sensor S3. The cylinder pressure sensor CPS includes a boom cylinder pressure sensor S7, an arm cylinder pressure sensor S8, and a bucket cylinder pressure sensor S9. The boom cylinder pressure sensor S7 includes the boom bottom pressure sensor S7B and the boom rod pressure sensor S7R. The arm cylinder pressure sensor S8 includes the arm bottom pressure sensor S8B and the arm rod pressure sensor S8R. The bucket cylinder pressure sensor S9 includes the bucket bottom pressure sensor S9B and the bucket rod pressure sensor S9R. The payload information includes, for example, the weight of earth and sand taken into the bucket 6.

Some of the functions of the excavator controller 30 may be realized by another controller (control device). That is, the functions of the excavator controller 30 may be realized by a plurality of controllers. For example, the machine guidance function and the machine control function may be realized by respective dedicated controllers (control devices). The same applies to the functions of calculating payload information.

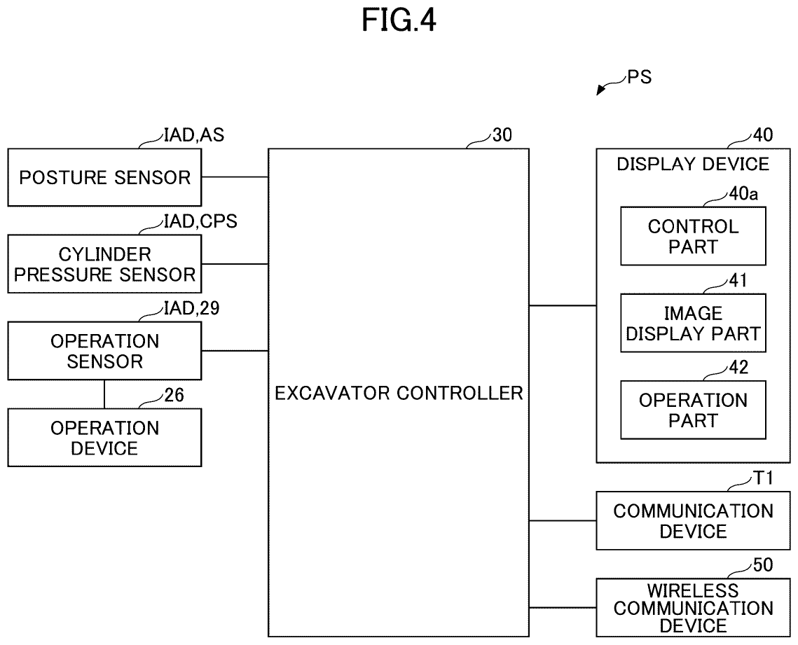

Next, a payload information management system PS configured to manage payload information will be described with reference to FIG. 4. FIG. 4 is a block diagram illustrating a configuration example of the payload information management system PS.

In the illustrated example, the payload information management system PS includes the excavator controller 30, the wireless communication device 50, the information acquisition device IAD, the display device 40, and the communication device T1. The information acquisition device IAD includes the operation sensor 29, the posture sensor AS, and the cylinder pressure sensor CPS. The excavator controller 30, the display device 40, the wireless communication device 50, and the communication device T1 are connected to each other via a controller area network (CAN).

The display device 40 is configured to display various types of information. In the present embodiment, the display device 40 is configured to display one or more images photographed by the photographing device serving as the space recognition device S6. The display device 40 operates by receiving supply of power from a storage battery. The display device 40 includes a control part 40a, an image display part 41, and an operation part 42.

The control part 40a controls an image displayed on the image display part 41. In the present embodiment, the control part 40a includes a computer including a CPU, an RAM, an NVRAM, an ROM, and an input/output interface. In this case, the control part 40a reads out, from the ROM, software (a program) corresponding to each functional element, and reads the software in the RAM, thereby causing the CPU to execute a corresponding process. However, the functional element may include hardware or a combination of software and hardware. The image displayed on the image display part 41 may be controlled by the excavator controller 30 or the space recognition device S6.

The image display part 41 displays a home screen including an image photographed by at least one of the photographing devices serving as the space recognition device S6. The photographed image may be, for example, a rear image photographed by the rear camera S6B, a left image photographed by the left camera S6L, or a right image photographed by the right camera S6R. The photographed image may be, for example, a bird's-eye view image that is a combination of the images photographed by the rear camera S6B, the left camera S6L, and the right camera S6R. The photographed image may be two or more images selected from the rear image, the left image, the right image, and the bird's-eye view image. The home screen includes, for example, state information indicating a state of the work machine 100 or setting information indicating content of various settings of the work machine 100.

The operation part 42 is a switch panel including a hardware switch. The operation part 42 may be a touch panel. In the illustrated example, the operation part 42 is disposed below the image display part 41, and includes a push switch 42a configured to change (switch) a screen or image displayed by the image display part 41. However, the arrangement of the operation part 42 is not limited to the above-described example. For example, the operation part 42 may be disposed on the operation lever, or may be disposed on a left or right console on a left or right side of the driver's seat. In addition to the operation part 42 provided in the display device 40, a driver's seat-side operation part having the same function as that of the operation part 42 may be disposed on at least one of the operation lever, the left console, or the right console.

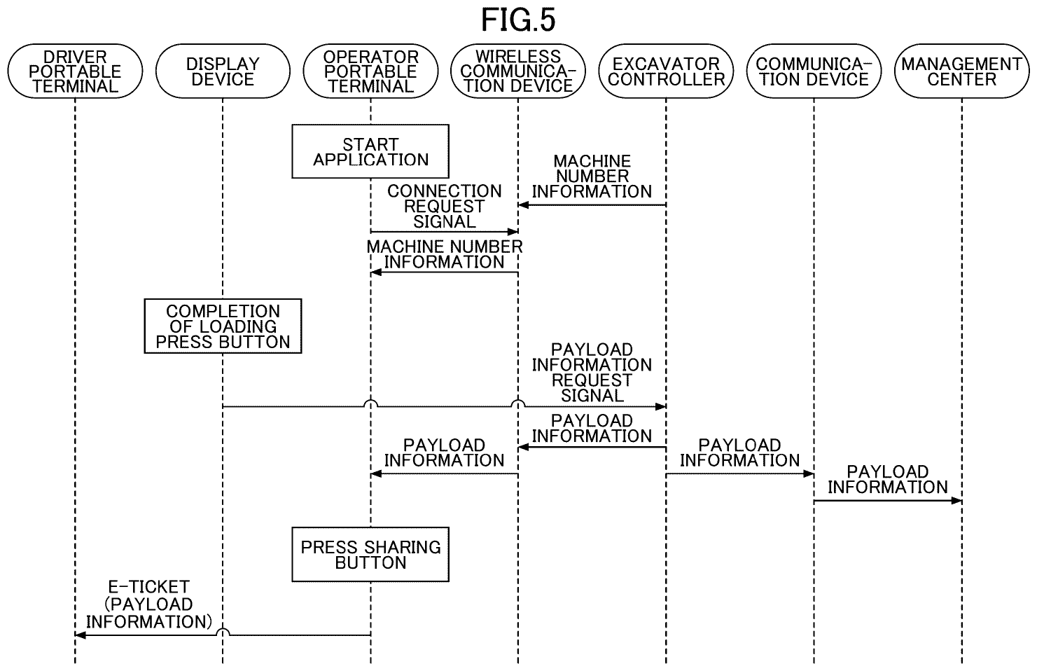

Here, a flow of payload information exchanged between the excavator controller 30, the wireless communication device 50, the display device 40, the management center 300, the operator portable terminal device SP1, the driver portable terminal device SP2, and the communication device T1 will be described with reference to FIG. 5. FIG. 5 is a flow diagram illustrating an example of the flow of payload information.

First, the operator OP of the work machine 100 enters the cab 10 of the work machine 100, and starts a payload information management application, which is a dedicated application (software) in the operator portable terminal device SP1. This payload information management application is software for receiving payload information from the work machine 100, generating an E-ticket based on the received payload information, and transmitting the generated E-ticket to the driver portable terminal device SP2.

The E-ticket is an electronic slip transmitted from the operator OP of the work machine 100 to the driver DV of the delivery vehicle 200. In the illustrated example, the E-ticket is generated based on the payload information. Specifically, the E-ticket is data in a PDF format, and is generated not to be editable. However, the E-ticket may be data in a text format.

In the illustrated example, the operator OP executes pairing using a passkey when connecting the operator portable terminal device SP1 and the wireless communication device 50 using Bluetooth (registered trademark) for the first time. In the second and subsequent times of connection, the operator OP can use the direct wireless communication between the operator portable terminal device SP1 and the wireless communication device 50 only by bringing the operator portable terminal device SP1 into the cab 10 without inputting the passkey.

Once the payload information management application is started, the operator portable terminal device SP1 transmits a connection request signal to the wireless communication device 50. The wireless communication device 50 that received the connection request signal transmits machine number information to the operator portable terminal device SP1. The machine number information is information of a machine number of the work machine 100 including the wireless communication device 50. The machine number information is previously stored in the excavator controller 30, and includes machine numbers of a predetermined number of characters and numbers. The excavator controller 30 repeatedly transmits the machine number information to the wireless communication device 50 at a predetermined cycle. Therefore, the wireless communication device 50 typically receives the machine number information from the excavator controller 30 before receiving the connection request signal.

Subsequently, when, following the completion of a loading operation by the work machine 100, the operator OP presses a push switch corresponding to a loading completion button image on the screen displayed on the display device 40, the display device 40 transmits a payload information request signal to the excavator controller 30.

Subsequently, the excavator controller 30 that received the payload information request signal transmits un-transmitted payload information to the wireless communication device 50 as the current payload information. The wireless communication device 50 that received the current payload information forwards the current payload information to the operator portable terminal device SP1. The current payload information refers to payload information generated based on information (information from the information acquisition device IAD) acquired by the excavator controller 30 after the transmission of the previous payload information, or to initial payload information without any previous payload information.

Subsequently, the operator portable terminal device SP1 that received the current payload information displays the current payload information on a display part (touch panel) of the operator portable terminal device SP1. At this stage, the operator OP can touch the display part of the operator portable terminal device SP1, thereby adding various information to the payload information to generate the E-ticket.

Subsequently, the operator OP touches a portion corresponding to a sharing button image displayed on the display part of the operator portable terminal device SP1, thereby transmitting the generated E-ticket to the driver portable terminal device SP2.

The driver portable terminal device SP2 that received the E-ticket can display the E-ticket on a display part (touch panel) of the driver portable terminal device SP2. Therefore, the driver DV of the delivery vehicle 200 can readily confirm, on the display part of the driver portable terminal device SP2, the content of the payload information of an object loaded on the bed of the delivery vehicle 200 driven by the driver DV.

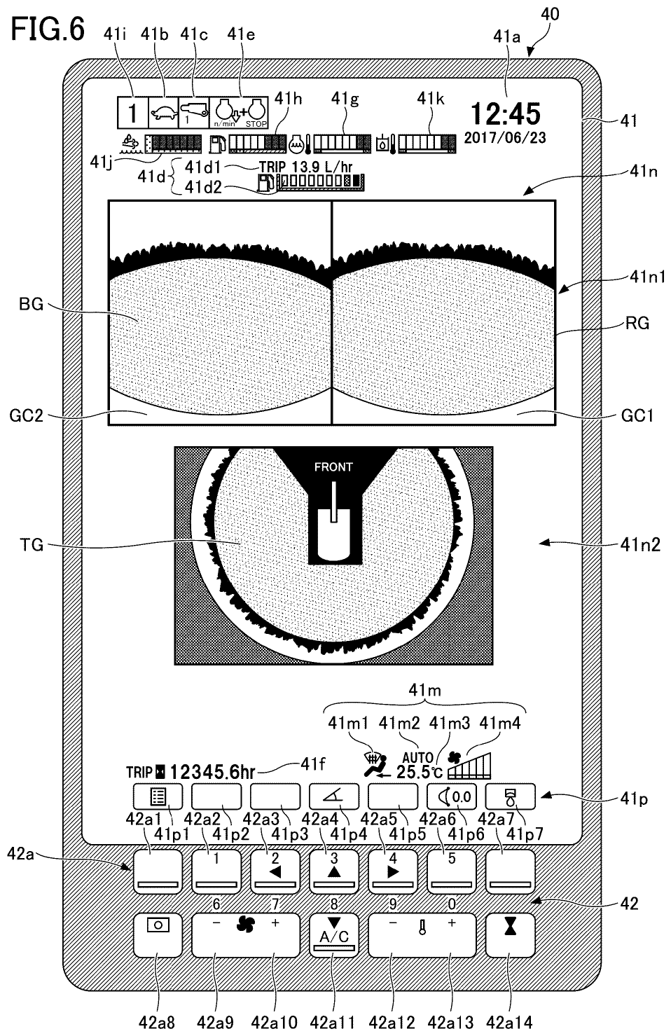

Next, a configuration example of the image display part 41 and the operation part 42 of the display device 40 will be described with reference to FIG. 6. FIG. 6 is a diagram illustrating the configuration example of the image display part 41 and the operation part 42 of the display device 40. The example illustrated in FIG. 6 illustrates a screen displayed on the image display part 41 before pressing of the push switch 42a of the operation part 42, i.e., a state in which a home screen is displayed that includes a right image RG, a rear image BG, and a bird's-eye view image TG, which are photographed by respective photographing devices serving as the space recognition device S6. The home screen is a screen displayed during operation of the work machine 100.

When the predetermined push switch 42a in the operation part 42 is pressed in the state in which the home screen is displayed, the image display part 41 displays a different screen. For example, the image display part 41 displays different information on the portion in which the bird's-eye view image TG was displayed, without changing the sizes of the right image RG and the rear image BG before and after pressing of the push switch 42a in the operation part 42. Specifically, the image display part 41 switches the currently displayed bird's-eye view image TG to an image corresponding to the predetermined push switch 42a, i.e., an information image (sub-screen for displaying a menu), such as, for example, a state display image (sub-screen for displaying a state) indicating a state of the work machine 100 or a setting display image (sub-screen for displaying settings) indicating various settings of the work machine 100.

First, the image display part 41 will be described. As illustrated in FIG. 6, the image display part 41 includes a date-and-time display section 41a, a traveling mode display section 41b, an attachment display section 41c, a fuel consumption display section 41d, an engine control state display section 41e, an engine operating time display section 41f, a cooling water temperature display section 41g, a remaining fuel amount display section 41h, a rotation speed level display section 41i, a remaining urea water amount display section 41j, a hydraulic oil temperature display section 41k, an air conditioner operating state display section 41m, an image display section 41n, and a switch image display section 41p.

The traveling mode display section 41b, the attachment display section 41c, the engine control state display section 41e, the rotation speed level display section 41i, and the air conditioner operating state display section 41m are sections for displaying setting state information, which is information of the setting state of the work machine 100. The fuel consumption display section 41d, the engine operating time display section 41f, the cooling water temperature display section 41g, the remaining fuel amount display section 41h, the remaining urea water amount display section 41j, and the hydraulic oil temperature display section 41k are sections for displaying operating state information, which is information of the operating state of the work machine 100.

Specifically, the date-and-time display section 41a is a section for displaying the current date and time. The traveling mode display section 41b is a section for displaying the current traveling mode. The attachment display section 41c is a section for displaying an image including an attachment that is currently attached. The fuel consumption display section 41d is a section for displaying fuel consumption information calculated by the excavator controller 30. The fuel consumption display section 41d includes an average fuel consumption display section 41d1 for displaying lifetime average fuel consumption or sectional average fuel consumption, and an instantaneous fuel consumption display section 41d2 for displaying instantaneous fuel consumption.

The engine control state display section 41e is a section for displaying the control state of the engine 11. The engine operating time display section 41f is a section for displaying a cumulative operating time of the engine 11. The cooling water temperature display section 41g is a section for displaying the current temperature of the engine cooling water. The remaining fuel amount display section 41h is a section for displaying the remaining amount of fuel stored in a fuel tank. The rotation speed level display section 41i is a section for displaying, as an image, the current level set by a dial 75. FIG. 6 illustrates a state in which a first level is selected. The remaining urea water amount display section 41j is a section for displaying, as an image, the remaining amount of urea water stored in a urea water tank. The hydraulic oil temperature display section 41k is a section for displaying the temperature of the hydraulic oil in a hydraulic oil tank.

The air conditioner operating state display section 41m includes an air outlet display section 41m1 for displaying the current position of an air outlet, an operation mode display section 41m2 for displaying the current operation mode, a temperature display section 41m3 for displaying the current set temperature, and an air volume display section 41m4 for displaying the current set air volume.

The image display section 41n is a section for displaying an image photographed by the photographing device serving as the space recognition device S6. In the example illustrated in FIG. 6, the image display section 41n displays the right image RG, the rear image BG, and the bird's-eye view image TG. The right image RG is an image of the space rightward the work machine 100, and includes an image GC1 of the right end of the upper surface of the upper slewing body 3. The right image RG is a real viewpoint image generated by the control part 40a, and is generated based on an image acquired by the right camera S6R. The rear image BG is an image of the space rearward of the work machine 100, and includes an image GC2 of the counterweight. The rear image BG is a real viewpoint image generated by the control part 40a, and is generated based on an image acquired by the rear camera S6B. The bird's-eye view image TG is a virtual viewpoint image generated by the control part 40a, and is generated based on the images acquired by the rear camera S6B, the left camera S6L, and the right camera S6R. An excavator figure corresponding to the work machine 100 is disposed at the center of the bird's-eye view image. This enables the operator OP to intuitively understand the positional relationship between the work machine 100 and objects existing around the work machine 100.

Also, the image display section 41n includes a first image display section 41n1 located in an upper portion, and a second image display section 41n2 located in a lower portion. In the example illustrated in FIG. 6, the right image RG and the rear image BG are disposed in the first image display section 41n1, and the bird's-eye view image TG is disposed in the second image display section 41n2. The image display section 41n may be such that the bird's-eye view image TG is disposed in the first image display section 41n1, and the rear image BG and the right image RG are disposed in the second image display section 41n2.

Also, the image display section 41n may be configured to simultaneously display a left image. In this case, the image display section 41n may be such that the left image and the right image RG are disposed in the first image display section 41n1, and the rear image BG and the bird's-eye view image TG are disposed in the second image display section 41n2. In this case, the left image may be disposed on the left side of the first image display section 41n1, and the right image RG may be disposed on the right side of the first image display section 41n1.

Also, in the example illustrated in FIG. 6, the right image RG and the rear image BG are disposed in contact with each other in the horizontal direction, but may be disposed with a gap. Also, in the example illustrated in FIG. 6, the image display section 41n is a vertically long section, but the image display section 41n may be a horizontally long section. In the case in which the image display section 41n is a horizontally long section, the image display section 41n may include the bird's-eye view image TG disposed on the left side as the first image display section 41n1, and the rear image BG and the right image RG disposed on the right side as the second image display section 41n2. In this case, these images may be horizontally disposed with a gap, or the position of the bird's-eye view image TG is exchanged with the position of the rear image BG and the right image RG.

The switch image display section 41p includes a first switch image display section 41p1 to a seventh switch image display section 41p7. In the example illustrated in FIG. 6, the first switch image display section 41p1 to the seventh switch image display section 41p7 are horizontally disposed at intervals at the lowest part of the image display part 41. Icons representing the functions of the push switches 42a1 to 42a7 are displayed in the first switch image display section 41p1 to the seventh switch image display section 41p7.

A menu detail item icon for displaying menu detail items is displayed in the first switch image display section 41p1. When the push switch 42a1 corresponding to the first switch image display section 41p1 is pressed by the operator OP, the icons displayed in the second switch image display section 41p2 to the seventh switch image display section 41p7 are switched to icons associated with the menu detail items.

In the example illustrated in FIG. 6, an icon for displaying information of a digital level is displayed in the fourth switch image display section 41p4. When the push switch 42a4 corresponding to the fourth switch image display section 41p4 is pressed by the operator OP, the bird's-eye view image TG displayed in the second image display section 41n2 is switched to an image (sub-screen) indicating information of the digital level. In this state, the rear image BG and the right image RG displayed in the first image display section 41n1 are continuously displayed to remain unchanged in size. However, the image (sub-screen) indicating information of the digital level may be displayed in the first image display section 41n1. In this case, the rear image BG and the right image RG displayed in the first image display section 41n1 may be displayed in the second image display section 41n2 instead of the bird's-eye view image TG.

An icon for displaying information of information-based construction is displayed in the sixth switch image display section 41p6. When the push switch 42a6 corresponding to the sixth switch image display section 41p6 is pressed by the operator OP, the bird's-eye view image TG displayed in the second image display section 41n2 is switched to an image (sub-screen) indicating information of the information-based construction. In this state, the rear image BG and the right image RG displayed in the first image display section 41n1 are continuously displayed to remain unchanged in size. However, the image (sub-screen) indicating information of the information-based construction may be displayed in the first image display section 41n1. In this case, the rear image BG and the right image RG displayed in the first image display section 41n1 may be displayed in the second image display section 41n2 instead of the bird's-eye view image TG.

An icon for displaying information of a crane mode is displayed in the seventh switch image display section 41p7. When the push switch 42a7 corresponding to the seventh switch image display section 41p7 is pressed by the operator OP, the bird's-eye view image TG displayed in the second image display section 41n2 is switched to an image (sub-screen) indicating information of the crane mode. In this state, the rear image BG and the right image RG displayed in the first image display section 41n1 are continuously displayed to remain unchanged in size. However, the image (sub-screen) indicating information of the crane mode may be displayed in the first image display section 41n1. In this case, the rear image BG and the right image RG displayed in the first image display section 41n1 may be displayed in the second image display section 41n2 instead of the bird's-eye view image TG.

In the example illustrated in FIG. 6, no icon is displayed in the second switch image display section 41p2, the third switch image display section 41p3, and the fifth switch image display section 41p5. Therefore, even if the push switches 42a2, 42a3, and 42a5 respectively corresponding to the second switch image display section 41p2, the third switch image display section 41p3, and the fifth switch image display section 41p5 are pressed by the operator OP, no change occurs in the images displayed on the image display part 41.

The icons displayed in the first switch image display section 41p1 to the seventh switch image display section 41p7 are not limited to the above-described examples, and icons for displaying other information may be displayed.

Next, the operation part 42 will be described. As illustrated in FIG. 6, the operation part 42 includes the push switches 42a of a button type corresponding to the first switch image display section 41p1 to the seventh switch image display section 41p7. In the example illustrated in FIG. 6, the operation part 42 includes seven push switches 42a1 to 42a7 arranged in the upper row and seven push switches 42a8 to 42a14 arranged in the lower row. The push switches 42a8 to 42a14 are respectively arranged below the push switches 42a1 to 42a7. However, the number, form, and arrangement of the push switches 42a of the operation part 42 are not limited to the above-described example, and the functions of a plurality of button-type switches may be integrated into one, like in a jog wheel, a jog switch, or the like. The operation part 42 may be configured as a member separate from the display device 40. Also, another possible form is a touch panel in which the image display part 41 and the operation part 42 are integrated. In this touch panel, the first switch image display section 41p1 to the seventh switch image display section 41p7 may be directly touched.

The push switches 42a1 to 42a7 are arranged below the first switch image display section 41p1 to the seventh switch image display section 41p7 to correspond to the first switch image display section 41p1 to the seventh switch image display section 41p7, respectively. The push switches 42a1 to 42a7 function as push switches configured to select the first switch image display section 41p1 to the seventh switch image display section 41p7, respectively. Since the push switches 42a1 to 42a7 are arranged below the first switch image display section 41p1 to the seventh switch image display section 41p7 to correspond to the first switch image display section 41p1 to the seventh switch image display section 41p7, the operator OP can intuitively select an intended one of the first switch image display section 41p1 to the seventh switch image display section 41p7.

The push switch 42a8 is a switch configured to switch a photographed image displayed on the image display section 41n. Every time the push switch 42a8 is pressed, the photographed image displayed in the first image display section 41n1 of the image display section 41n is switched, for example, between the rear image, the left image, the right image, and the bird's-eye view image. Alternatively, every time the push switch 42a8 is pressed, the photographed image displayed in the second image display section 41n2 of the image display section 41n may be switched, for example, between the rear image, the left image, the right image, and the bird's-eye view image.

Alternatively, every time the push switch 42a8 is pressed, the photographed image displayed in the first image display section 41n1 of the image display section 41n may be exchanged with the photographed image displayed in the second image display section 41n2. As described above, the push switch 42a8 serving as the operation part 42 may be used to switch the photographed image displayed in the first image display section 41n1 or the second image display section 41n2, or may be used to exchange the photographed images displayed in the first image display section 41n1 and the photographed image displayed in the second image display section 41n2. Also, a switch configured to switch the screen displayed in the second image display section 41n2 may be provided separately.

The push switches 42a9 and 42a10 are switches configured to adjust the air volume of an air conditioner. In the example illustrated in FIG. 6, the air volume of the air conditioner decreases when the push switch 42a9 is pressed, and the air volume of the air conditioner increases when the push switch 42a10 is pressed.

The push switch 42a11 is a switch configured to turn on or off cooling and heating functions. In the example illustrated in FIG. 6, the cooling and heating functions are turned on or off every time the push switch 42a11 is pressed.

The push switches 42a12 and 42a13 are switches configured to adjust a set temperature of the air conditioner. In the example illustrated in FIG. 6, the set temperature decreases when the push switch 42a12 is pressed, and the set temperature increases when the push switch 42a13 is pressed.

The push switch 42a14 is a switch configured to switch the display of the engine operating time display section 41f.

Also, the push switches 42a2 to 42a6 and 42a9 to 42a13 are each configured to receive an input of the number displayed on or near the switch. When a cursor is displayed on the image display section 41n, the push switches 42a3, 42a4, 42a5, and 42a11 are configured to move the cursor leftward, upward, rightward, and downward, respectively.

The functions assigned to the switches 42a1 to 42a7 and 42a8 to 42a14 are merely examples, and may be configured to perform other functions.

As described above, when the push switch 42a1 corresponding to the first switch image display section 41p1 is pressed in a state in which the right image RG, the rear image BG, and the bird's-eye view image TG are displayed in the image display section 41n, new icons (icons representing functions newly assigned to the push switches 42a1 to 42a7) are displayed in the second switch image display section 41p2 to the seventh switch image display section 41p7 in a state in which the right image RG and the rear image BG are displayed. Therefore, the operator OP can confirm the new icons while confirming the right image RG and the rear image BG.

Also, in the above example, when one of the push switches 42a1 to 42a7 respectively corresponding to the first switch image display section 41p1 to the seventh switch image display section 41p7 is pressed in a state in which the right image RG, the rear image BG, and the bird's-eye view image TG are displayed in the image display section 41n, the bird's-eye view image TG is switched to an information image indicating information corresponding to the selected switch image display section 41p. In this manner, since the information image is displayed in the state in which the right image RG and the rear image BG are displayed, the operator OP can continue to monitor the surroundings (rearward and rightward spaces) in a state in which the information image is displayed. Therefore, the operator OP can operate the work machine 100 in the state in which the information image is displayed.

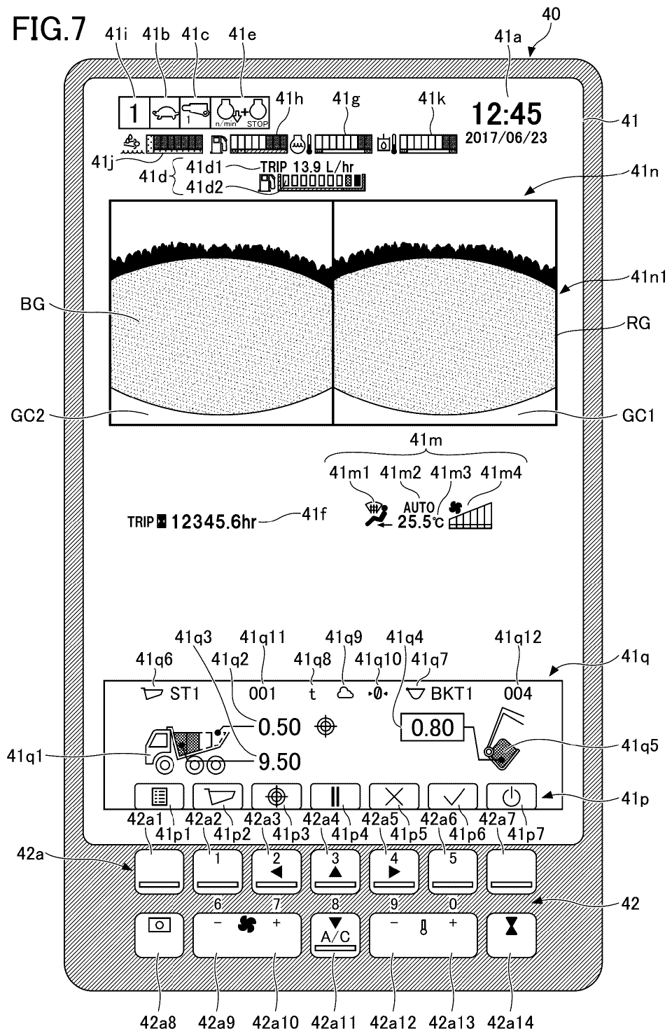

Next, a display example of the information image displayed in the image display part 41 of the display device 40 will be described with reference to FIG. 7. FIG. 7 is a diagram illustrating a screen including a payload information image 41q, which is an example of the information image displayed in the image display part 41 of the display device 40. The payload information image 41q displayed in the image display part 41 of FIG. 7 is displayed, for example, when the push switch 42a corresponding to the switch image display section 41p (one of the first switch image display section 41p1 to the seventh switch image display section 41p7 of FIG. 6) including a payload information icon (not shown) is pressed.

In the example illustrated in FIG. 7, a menu detail item icon for displaying menu detail items is displayed in the first switch image display section 41p1. When the push switch 42a1 corresponding to the first switch image display section 41p1 is pressed by the operator OP, the icons displayed in the second switch image display section 41p2 to the seventh switch image display section 41p7 are switched to icons associated with the menu detail items.

An icon for displaying a screen for setting information of the delivery vehicle 200 (an icon of the bed of the delivery vehicle 200) is displayed in the second switch image display section 41p2. When the push switch 42a2 corresponding to the second switch image display section 41p2 is pressed by the operator OP, a screen for setting information of the delivery vehicle 200 is displayed in the image display part 41. The information of the delivery vehicle 200 includes the maximum loading weight and the like.

An icon for displaying a screen for setting the target loading weight (an icon representing a target) is displayed in the third switch image display section 41p3. When the push switch 42a3 corresponding to the third switch image display section 41p3 is pressed by the operator OP, a screen for setting the target loading weight is displayed in the image display part 41.

An icon (an icon of two vertically extending lines) for temporarily suspending calculation using the weight of an object taken into the bucket 6 is displayed on the fourth switch image display section 41p4. When the push switch 42a4 corresponding to the fourth switch image display section 41p4 is pressed by the operator OP, the image display part 41 displays, for example, a text message indicating that the calculation of the weight of the object taken into the bucket 6 is suspended. During the suspended period, even if the object taken into the bucket 6 is dumped (released) to anywhere (including the bed of the delivery vehicle 200), the weight of that object is not added to the loading weight (the weight of the object loaded on the bed of the delivery vehicle 200). When the push switch 42a4 is pressed again by the operator OP, this suspension is canceled.

An icon (icon of an X mark) for avoiding performing the calculation using the weight of the object currently taken into the bucket 6 is displayed in the fifth switch image display section 41p5. When the push switch 42a5 corresponding to the fifth switch image display section 41p5 is pressed by the operator OP, the image display part 41 displays, for example, a text message indicating that the calculation using the weight of the object currently taken into the bucket 6 is not performed. In this case, even if the object currently taken into the bucket 6 is dumped (released) to anywhere (including the bed of the delivery vehicle 200), the weight of the object currently taken into the bucket 6 is not added to the loading weight.

An icon (icon of a check mark) for informing the excavator controller 30 of completion of a loading operation is displayed in the sixth switch image display section 41p6. When the push switch 42a6 corresponding to the sixth switch image display section 41p6 is pressed by the operator OP, the payload information request signal is transmitted from the display device 40 to the excavator controller 30, and for example, a text message indicating the completion of the loading operation is displayed in the image display part 41. Therefore, the push switch 42a6 functions as a “loading completion button”.

An icon (an icon of a power supply mark) for displaying a home screen is displayed in the seventh switch image display section 41p7. When the push switch 42a7 corresponding to the seventh switch image display section 41p7 is pressed by the operator OP, a home screen as illustrated in FIG. 6 is displayed in the image display part 41.

In the example illustrated in FIG. 7, the payload information image 41q includes a truck icon 41q1, a target loading weight image 41q2, an in-vessel loading image 41q3, an in-bucket loading image 41q4, a bucket icon 41q5, a truck name image 41q6, a bucket name image 41q7, a measurement unit image 41q8, a cloud icon 41q9, a zero adjustment icon 41q10, a truck counter image 41q11, and a bucket counter image 41q12. The truck icon 41q1 is an icon representing a loading state of the object loaded on the bed of the delivery vehicle 200. In the illustrated example, the truck icon 41q1 is configured to represent the loading state of the delivery vehicle 200 in six stages: “none (empty)”, “small”, “medium”, “just before full”, “full”, and “over”, by changing the size (the area of a lighting portion) of an image portion representing the object loaded on the bed. FIG. 7 illustrates that the loading state is “medium”. The truck icon 41q1 may be configured to be blacked out when the loading operation is suspended.

The target loading weight image 41q2 is an image representing the target loading weight of the object loaded on the bed of the delivery vehicle 200. In the illustrated example, the target loading weight is such that an initial value is the maximum loading weight of the delivery vehicle 200, and decreases as an object is loaded on the bed of the delivery vehicle 200. Also, a color of display of the target loading weight may change in accordance with the loading state or the like.

The in-vessel loading image 41q3 is an image representing an in-vessel load, which is the weight of the object already loaded on the bed of the delivery vehicle 200. The color of display of the in-vessel load may change in accordance with the loading state or the like, as in the target loading weight. In this case, the loading state may be determined based on a ratio of the in-vessel load to the maximum loading weight.

The in-bucket loading image 41q4 is an image representing an in-bucket load, which is the weight of the object already taken into the bucket 6. The color of display of the in-bucket load may change in accordance with the loading state or the like, as in the target loading weight and the in-vessel load. In this case, the loading state may be determined based on a ratio of the total weight of the in-vessel load and the in-bucket weight to the maximum loading weight.

FIG. 7 illustrates that the target loading weight is 0.5 tons and the in-vessel load is 9.5 tons. This is based on the fact that the maximum loading weight of the delivery vehicle 200 is 10 tons. Also, FIG. 7 illustrates that the in-bucket load is 0.8 tons, which exceeds the target loading weight. That is, FIG. 7 illustrates that, when the object in the bucket 6 is all loaded on the bed of the delivery vehicle 200, the total weight of the in-bucket load and the in-vessel load exceeds the maximum loading weight of the delivery vehicle 200.

The bucket icon 41q5 is an icon representing a state of the bucket 6. In the illustrated example, the bucket icon 41q5 is configured to represent the loading state of the bucket 6 in three stages: “with soil (measurement accuracy: normal)”, “with soil (measurement accuracy: low)”, and “without soil”, by changing the size of an image portion (the area of a lighting portion) representing an object loaded into the bucket 6. FIG. 7 illustrates that the loading state is “with soil (measurement accuracy: normal)”. The bucket icon 41q5 may be configured to be blacked out when the loading operation is suspended.

The truck name image 41q6 is an image representing a name of the delivery vehicle 200 that is a target of a loading operation. In FIG. 7, a truck name image 41q6 indicates, along with an icon representing the bed of the delivery vehicle 200, that the name of the delivery vehicle 200 that is a target of a loading operation is “ST1”.

The bucket name image 41q7 is an image representing a name of the bucket 6 attached to the work machine 100 performing a loading operation. In FIG. 7, the bucket name image 41q7 indicates, along with an icon representing the bucket 6, that the name of the bucket 6 attached to the work machine 100 performing a loading operation is “BKT1”.

The measurement unit image 41q8 is an image representing a unit of each load (weight) to be displayed. In the illustrated example, the unit is selected from “t” (ton) and “lb” (pound). FIG. 7 illustrates that the unit is “t”(ton).

The cloud icon 41q9 is an icon representing a state of connection with a server (the management center 300). In the illustrated example, the cloud icon 41q9 is configured such that the operator OP can distinguish a “state of performing communication with the server” from a “state of not performing communication with the server”, by changing the color of the icon. FIG. 7 illustrates the “state of performing communication with the server”.

The zero adjustment icon 41q10 is an icon representing a state in which zero adjustment is performed. In the illustrated example, the zero adjustment icon 41q10 is configured such that the operator OP can distinguish a “state in which zero adjustment is not performed” from a “state in which zero adjustment is already performed”, by changing the color of the icon. The zero adjustment is an adjustment performed when the in-bucket load is a value other than zero even though no object is taken into the bucket 6. The zero adjustment being already performed means, for example, that, when the in-bucket load is a value other than zero even though no object is taken into the bucket 6, an attachment is adjusted to have a predetermined posture and a predetermined reset button is pressed (as a result, the in-bucket load is adjusted to be zero). FIG. 7 illustrates the “state in which zero adjustment is already performed”. The “state in which zero adjustment is already performed” may be valid only for a single loading operation performed subsequently, or may be continuously valid for a plurality of loading operations performed subsequently. When the “state in which zero adjustment is already performed” is valid only for a single loading operation performed subsequently, the “state in which zero adjustment is already performed” may be automatically switched to the “state in which zero adjustment is not performed” at the time when soil is dumped (released).

The truck counter image 41q11 is an image illustrating the number of the delivery vehicles 200 in which loading was performed. In the illustrated example, the truck counter image 41q11 illustrates the number of the delivery vehicles 200 in which loading was completed, after start of the payload information management application. FIG. 7 illustrates that the number of the delivery vehicles 200 in which loading was completed is one, i.e., the delivery vehicle 200 in which the current loading operation is being performed is the second delivery vehicle.

The bucket counter image 41q12 is an image indicating how many times loading has been performed, by the bucket 6, to the delivery vehicle 200 that is a target of the current loading operation. In the illustrated example, the bucket counter image 41q12 illustrates that loading has been already performed four times to the delivery vehicle 200 that is a target of the current loading operation.

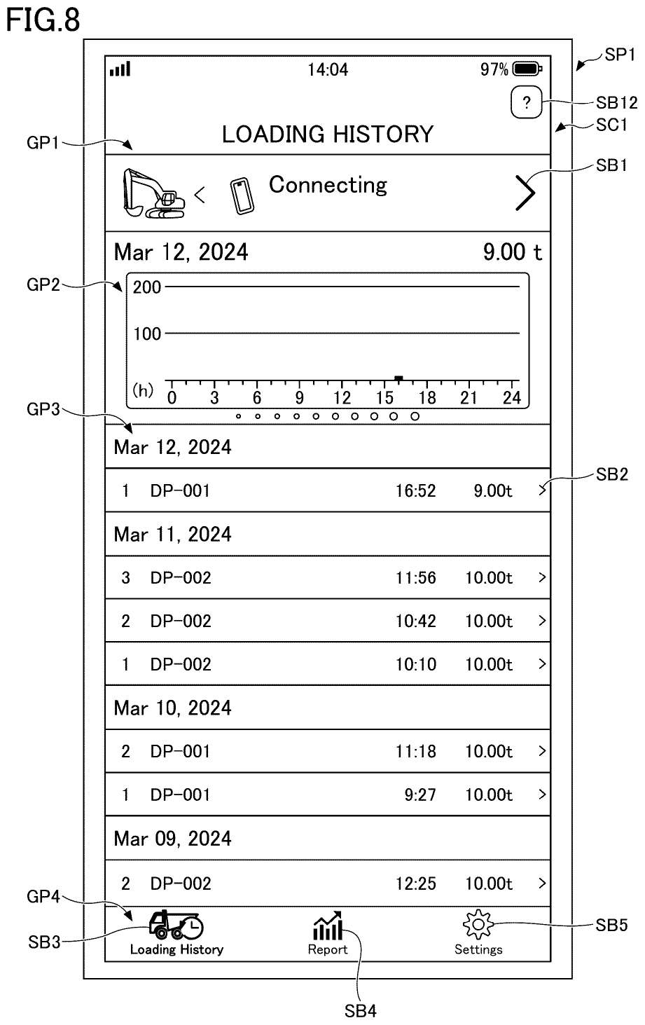

Next, an example of a screen displayed on the display part (touch panel) of the operator portable terminal device SP1 will be described with reference to FIG. 8. FIG. 8 is a diagram illustrating a configuration example of a history screen SC1 displayed on the display part (touch panel) of the operator portable terminal device SP1.

The history screen SC1 is a screen displayed on the display part (touch panel) of the operator portable terminal device SP1 in which the payload information management application is started. Specifically, the history screen SC1 includes a machine selection function display section GP1, a graph display section GP2, a history display section GP3, and a screen icon display section GP4.

The machine selection function display section GP1 is a section for displaying various images, such as, for example, an input form for selecting the work machine 100 to be connected through the direct wireless communication. Specifically, a software button SB1 represented by a symbol “>” is displayed in the machine selection function display section GP1. In the illustrated example, the software button SB1 is a pull-down button. The pull-down button is an example of the input form for enabling input of an item selected from a previously prepared list, and is also referred to as a “drop-down list button” or a “selection input button”. When the operator OP touches the software button SB1, a list of the work machines 100 that are connectable is displayed. Then, selecting and touching a desired work machine 100 from the displayed list of the work machines 100 causes the direct wireless communication to be performed between the wireless communication device 50 of the selected work machine 100 and the operator portable terminal device SP1. Then, payload information of the selected work machine 100 is displayed on the history screen SC1.

The graph display section GP2 is a section for displaying a graph based on the payload information. In the illustrated example, the graph display section GP2 displays a two-dimensional bar graph in which the horizontal axis indicates a point in time of today (Mar. 12, 2024) and the vertical axis indicates a loading weight (ton). Specifically, the graph display section GP2 in FIG. 8 illustrates that a cumulative value of the weight of earth and sand loaded by the work machine 100 onto the delivery vehicle 200 during a period from 16:00 (inclusive) to 17:00 (exclusive) on Mar. 12, 2024 is 9 tons.

The history display section GP3 is a section for displaying a list of the payload information that is already received. In the illustrated example, the history display section GP3 displays heading information corresponding to one piece of the payload information received on Mar. 12, 2024, heading information corresponding to three pieces of the payload information received on Mar. 11, 2024, heading information corresponding to two pieces of the payload information received on Mar. 10, 2024, and heading information corresponding to the second one of two pieces of the payload information received on Mar. 9, 2024. The heading information corresponding to the first piece of the two pieces of the payload information received on Mar. 9, 2024 is made visible by scrolling down the history screen SC1. The same applies to the payload information received on or before Mar. 8, 2024.

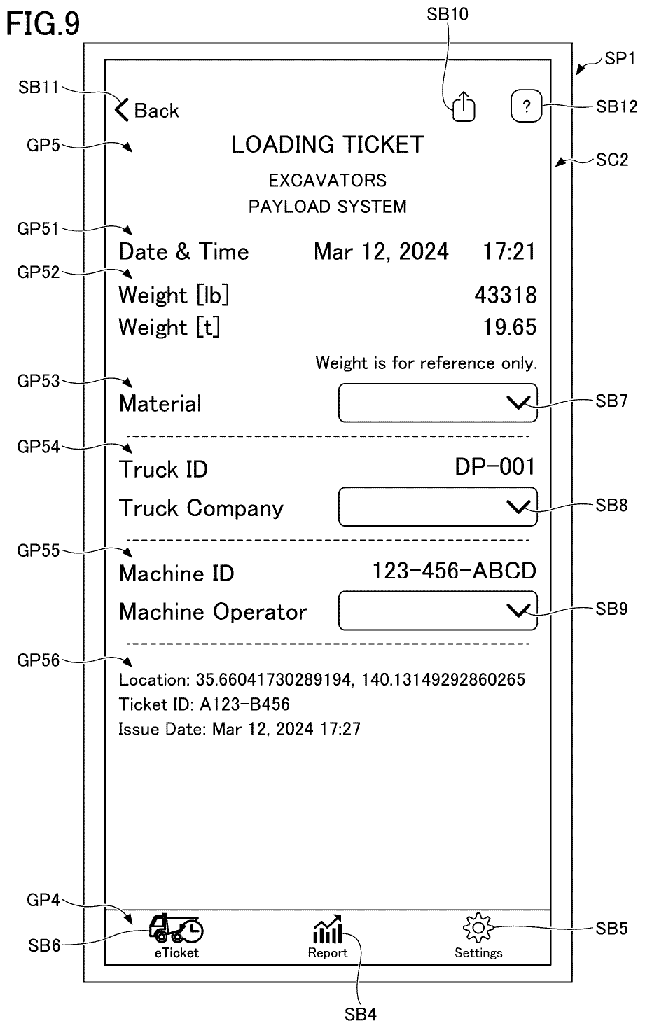

Each piece of the heading information includes a truck number, a reception time, a loading weight, and a software button SB2. Each piece of the heading information may include a machine number (identification number) of the work machine 100. The software button SB2 is used to display an E-ticket generation screen SC2 (see FIG. 9), which is a screen for generating an E-ticket of the payload information specified by the heading information. In the illustrated example, the software button SB2 is a software button configured to switch the history screen SC1 to the E-ticket generation screen SC2 (see FIG. 9). The operator OP can display the E-ticket generation screen SC2 by touching the software button SB2.

The history screen SC1 in FIG. 8 indicates that a single loading operation is performed to a dump truck identified by “DP-001” on Mar. 12, 2024 (today), three loading operations are performed to a dump truck identified by “DP-002” on Mar. 11, 2024 (yesterday), two loading operations are performed to the dump truck identified by “DP-001” on Mar. 10, 2024 (the day before yesterday), and two loading operations are performed to the dump truck identified by “DP-002”on Mar. 9, 2024 (two days before).

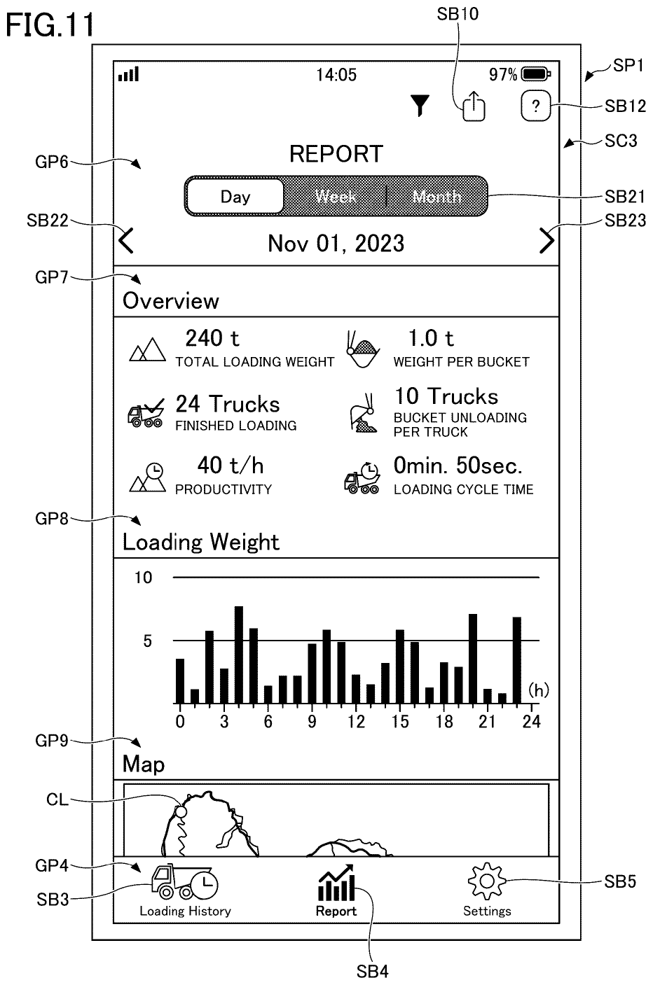

The screen icon display section GP4 is a section for displaying icons of selectable screens. In the illustrated example, a software button SB3 representing the history screen SC1, a software button SB4 representing a report screen SC3 (see FIG. 11), and a software button SB5 representing a setting screen (not shown) are displayed in the screen icon display section GP4. The software button SB3 representing the currently displayed history screen SC1 is displayed to be distinguishable from the software button SB4 and the software button SB5 corresponding to screens that are not currently displayed. In the illustrated example, the software button SB3 is displayed using a color different from colors of the software button SB4 and the software button SB5.

In the history screen SC1 illustrated in FIG. 8, the operator OP can display the report screen SC3 by touching the software button SB4, and can display the setting screen by touching the software button SB5. A software button SB12 configured to display a help screen (not shown) is displayed at the upper-right corner of the history screen SC1. By touching the software button SB12, the operator OP can display, on the display part of the operator portable terminal device SP1, a screen for displaying detailed information of the history screen SC1.

Every time a loading operation is completed, the operator OP can include the payload information into the operator portable terminal device SP1 by pressing the push switch 42a6 corresponding to the sixth switch image display section 41p6 in the payload information image 41q illustrated in FIG. 7. That is, every time the push switch 42a6 is pressed, the payload information is transmitted from the excavator controller 30 to the operator portable terminal device SP1 via the wireless communication device 50. Every time the payload information is received, new heading information is added to the history display section GP3.

Next, another example of a screen displayed on the display part (touch panel) of the operator portable terminal device SP1 will be described with reference to FIG. 9. FIG. 9 is a diagram illustrating a configuration example of the E-ticket generation screen SC2 displayed on the display part (touch panel) of the operator portable terminal device SP1.

The E-ticket generation screen SC2 is a screen configured to generate an E-ticket based on payload information. In the illustrated example, the E-ticket generation screen SC2 is displayed when the software button SB2 in the specific heading information is touched on the history screen SC1.

Specifically, the E-ticket generation screen SC2 includes the screen icon display section GP4 and an E-ticket editing section GP5.

Similar to the screen icon display section GP4 in the history screen SC1 illustrated in FIG. 8, the screen icon display section GP4 is a section for displaying icons of selectable screens. In the illustrated example, a software button SB6 representing the E-ticket generation screen SC2, the software button SB4 representing the report screen SC3 (see FIG. 11), and the software button SB5 representing the setting screen (not shown) are displayed in the screen icon display section GP4. That is, the screen icon display section GP4 of the E-ticket generation screen SC2 is different from the screen icon display section GP4 of the history screen SC1 in that the software button SB6 is included. The software button SB6 representing the currently displayed E-ticket generation screen SC2 is displayed to be distinguishable from the software button SB4 and the software button SB5 corresponding to screens that are not currently displayed. In the illustrated example, the software button SB6 is displayed using a color different from colors of the software button SB4 and the software button SB5.

The E-ticket editing section GP5 is a section for displaying information of the E-ticket. In the illustrated example, the E-ticket editing section GP5 includes a date-and-time display section GP51, a loading weight display section GP52, a type display section GP53, a truck information display section GP54, a work machine information display section GP55, and a position information display section GP56.

The date-and-time display section GP51 is a section for displaying date and time of completion of a loading operation. In the illustrated example, the date-and-time display section GP51 indicates that a loading operation is completed at 17:21 on Mar. 12, 2024.

The loading weight display section GP52 is a section for displaying a loading weight. In the illustrated example, the loading weight display section GP52 includes a section for displaying the loading weight in pounds and a section for displaying the loading weight in tons. Specifically, the loading weight display section GP52 indicates that objects of 43318 pounds, i.e., objects of 19.65 tons, are loaded. The text message “Weight is for reference only.” indicates that the value of the loading weight displayed in the loading weight display section GP52 is for reference only.

The type display section GP53 is a section for displaying types of loaded objects. Specifically, the type display section GP53 is configured such that the operator OP can input the types of the loaded objects. In the illustrated example, the type display section GP53 includes a pull-down button as a software button SB7. When the operator OP touches the software button SB7, a list of types of loaded objects is displayed. The types of the loaded objects are, for example, earth and sand, concrete, steel scraps, or the like. When a desired one is selected from the displayed list and touched, the type of the selected loaded object is displayed in the type display section GP53.

The truck information display section GP54 is a section for displaying information of the delivery vehicle 200. Specifically, the truck information display section GP54 is configured such that the operator OP can input the name of a company to which the delivery vehicle 200 belongs. In the illustrated example, the truck information display section GP54 includes a section for displaying an identification number of the delivery vehicle 200, and a pull-down button as a software button SB8. When the operator OP touches the software button SB8, a list of company names is displayed, and the operator OP can select a desired company name from the list. In FIG. 9, “DP-001” is displayed as the identification number of the delivery vehicle 200.

The work machine information display section GP55 is a section for displaying information of the work machine 100. Specifically, the work machine information display section GP55 is configured such that the operator OP can input the name of the operator OP operating the work machine 100. In the illustrated example, the work machine information display section GP55 includes a section for displaying an identification number of the work machine 100, and a pull-down button as a software button SB9. When the operator OP touches the software button SB9, a list of the operators OP is displayed, and the operator OP can select his or her own name from the list. In FIG. 9, “123-456-ABCD” is displayed as the identification number of the work machine 100.

The position information display section GP56 is a section for displaying information of a location at which a loading operation is performed. In the illustrated example, the position information display section GP56 displays position coordinates (latitude and longitude) specified based on an output of the positioning device PD mounted in the work machine 100.

Also, a software button SB10, a software button SB11, and a software button SB12 are displayed at the upper end of the E-ticket editing section GP5, and an information identification number of the E-ticket and an issue date and time of the E-ticket are displayed below the position information display section GP56. Specifically, in FIG. 9, “A123-B456” is displayed as the information identification number of the E-ticket, and “Mar 12, 2024 17:27” (at 17:27 on Mar. 12, 2024) is displayed as the issue date and time of the E-ticket. In the illustrated example, the information identification number of the E-ticket is generated by the excavator controller 30, and the payload information including the information identification number is transmitted from the excavator controller 30 to each of the operator portable terminal device SP1 and the management center 300.

The software button SB10 is a software button configured to share information between the operator portable terminal device SP1 and the driver portable terminal device SP2, and is also referred to as a “sharing button”. The operator OP can transmit the E-ticket in a PDF format to the driver portable terminal device SP2 by touching the sharing button. In the illustrated example, the issue date and time of the E-ticket is the date and time the software button SB10 is touched.

The software button SB11 is a software button configured to return to the history screen SC1. By touching the software button SB11, the operator OP can display again the history screen SC1, illustrated in FIG. 8, on the display part of the operator portable terminal device SP1.

The software button SB12 is a software button configured to display a help screen (not shown). By touching the software button SB12, the operator OP can display a screen displaying detailed information of the E-ticket on the display part of the operator portable terminal device SP1.

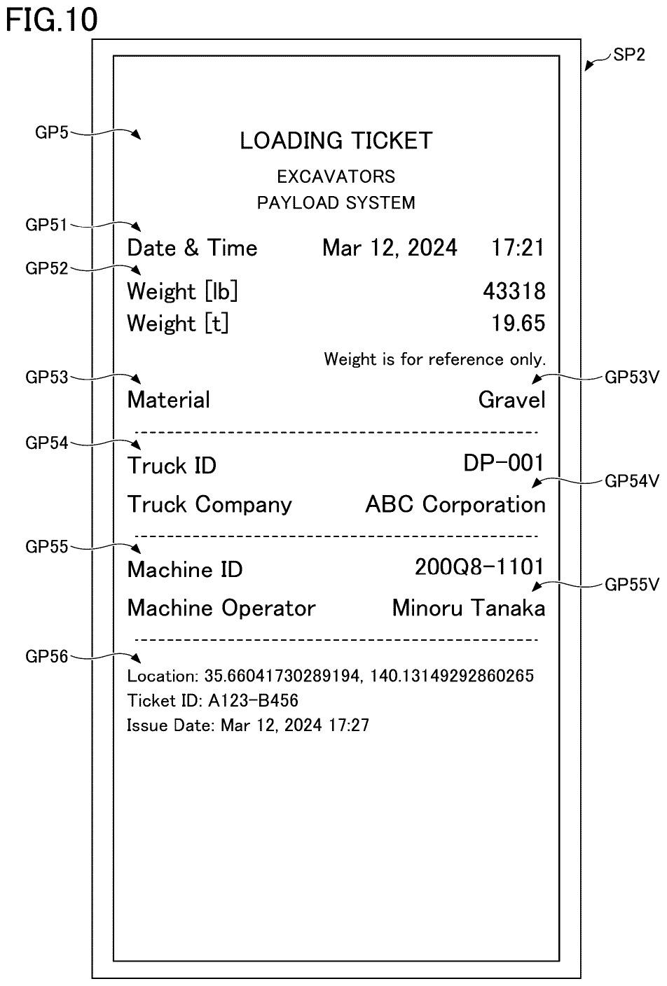

Next, an example of a screen displayed on the display part (touch panel) of the driver portable terminal device SP2 will be described with reference to FIG. 10. FIG. 10 is a diagram illustrating a configuration example of the E-ticket displayed on the display part (touch panel) of the driver portable terminal device SP2.

The E-ticket in a PDF format displayed on the display part (touch panel) of the driver portable terminal device SP2 is substantially the same as the content of the E-ticket generation screen SC2 (see FIG. 9) displayed on the display part (touch panel) of the operator portable terminal device SP1.

Specifically, the E-ticket in a PDF format displayed on the display part (touch panel) of the driver portable terminal device SP2 includes the date-and-time display section GP51, the loading weight display section GP52, the type display section GP53, the truck information display section GP54, the work machine information display section GP55, and the position information display section GP56.

“Gravel”, meaning earth and sand, is displayed in the type display section GP53 as GP53V, which is a value of a type of a loaded object selected on the E-ticket generation screen SC2. Similarly, “ABC Corporation” is displayed in the truck information display section GP54 as GP54V, which is a value of the company name selected on the E-ticket generation screen SC2 (the name of the company to which the delivery vehicle 200 belongs), and “Minoru Tanaka” is displayed in the work machine information display section GP55 as GP55V, which is a value of the name selected on the E-ticket generation screen SC2 (the name of the operator OP operating the work machine 100).

Next, yet another example of the screen displayed on the display part (touch panel) of the operator portable terminal device SP1 will be described with reference to FIG. 11. FIG. 11 is a diagram illustrating a configuration example of the report screen SC3 displayed on the display part (touch panel) of the operator portable terminal device SP1.

The report screen SC3 is a screen for displaying an aggregate value based on the acquired payload information. In the illustrated example, the report screen SC3 is displayed when the software button SB4 is touched on the history screen SC1 (see FIG. 8), the E-ticket generation screen SC2 (see FIG. 9), or the like.

Specifically, the report screen SC3 includes the screen icon display section GP4, an extraction condition selection section GP6, an aggregation result display section GP7, a temporal transition display section GP8, and a map display section GP9.

Similar to the screen icon display section GP4 in each of the history screen SC1 illustrated in FIG. 8 and the E-ticket generation screen illustrated in FIG. 9, the screen icon display section GP4 is a section for displaying icons of selectable screens. In the illustrated example, the software button SB3 representing the history screen SC1 (see FIG. 8), the software button SB4 representing the report screen SC3, and the software button SB5 representing a setting screen (not shown) are displayed in the screen icon display section GP4. The software button SB4 representing the currently displayed report screen SC3 is displayed to be distinguishable from the software button SB3 and the software button SB5 corresponding to screens that are not currently displayed. In the illustrated example, the software button SB4 is displayed using a color different from colors of the software button SB3 and the software button SB5. That is, the screen icon display section GP4 of the report screen SC3 is the same as the screen icon display section GP4 of the history screen SC1 except that the software button SB4 is displayed to be distinguishable.

The extraction condition selection section GP6 is a section for selecting daily aggregation, weekly aggregation, and monthly aggregation. In the illustrated example, a software button SB21 is displayed in the extraction condition selection section GP6. The software button SB21 is a software button including three sections: a left section having a heading of “Day” corresponding to the daily aggregation, a center section having a heading of “Week” corresponding to the weekly aggregation, and a right section having a heading of “Month” corresponding to the monthly aggregation. The operator OP can select the daily aggregation by touching the left section of the software button SB21, the weekly aggregation by touching the center section of the software button SB21, and the monthly aggregation by touching the right section of the software button SB21. FIG. 11 illustrates that the daily aggregation is selected and “Nov 01, 2023” (Nov. 1, 2023) is selected.

Also, a software button SB22 configured to shift the selected date and time to previous dates and times, and a software button SB23 configured to shift the selected date and time to subsequent dates and times are displayed in the extraction condition selection section GP6. In the example illustrated in FIG. 11, the operator OP can change the selected “Nov 01, 2023” (Nov. 1, 2023) to “Oct 31, 2023” (Oct. 31, 2023) by touching the software button SB22 only once, and can change the selected “Nov 01, 2023” (Nov. 1, 2023) to “Nov 02, 2023” (Nov. 2, 2023) by touching the software button SB23 only once. In the case in which the weekly aggregation is selected, the selected week is changed to the previous week when the software button SB22 is touched. In the case in which the monthly aggregation is selected, the selected month is changed to the previous month when the software button SB22 is touched. The same applies to the case in which the software button SB23 is touched.

An overview of the aggregation result is displayed in the aggregation result display section GP7. In the example illustrated in FIG. 11, the aggregation result display section GP7 indicates that the total loading weight on “Nov 01, 2023” (Nov. 1, 2023) is “240” tons, the loading weight per one time (per one bucket) is “1.0” ton, the number of the delivery vehicles 200 that are the targets of the loading operation is “24” delivery vehicles, the number of dumping operations (soil releasing operations) required for loading onto the single delivery vehicle 200 is “10” times, the loading weight per one hour is “40” tons, and the time required for the single loading operation is “50”seconds.

The temporal transition display section GP8 displays a temporal transition of various physical quantities. In the example illustrated in FIG. 11, the temporal transition display section GP8 displays a two-dimensional graph illustrating a temporal transition of the loading weight (tons). Specifically, the temporal transition display section GP8 displays a bar graph in which the vertical axis indicates a loading weight (tons) and the horizontal axis indicates a point in time. The height (value) of the bar graph illustrated in FIG. 11 is merely an example, and does not correspond to each value displayed in the aggregation result display section GP7.

A position on a map of a place where a loading operation is performed is indicated in the map display section GP9. In FIG. 11, the upper part of the map indicated in the map display section GP9 is illustrated, and the place where the loading operation of “Nov 01, 2023” (Nov. 1, 2023) is performed is illustrated by a circle CL on the map. The operator OP can visually confirm the remaining part of the map (the part below the upper part visible in FIG. 11) by scrolling down the report screen SC3.

Also, the software button SB10 and the software button SB12 are displayed on the report screen SC3.

The software button SB10 is a sharing button configured to share information between the operator portable terminal device SP1 and the driver portable terminal device SP2. The operator OP can transmit report information in a PDF format (the content displayed in FIG. 11) to the driver portable terminal device SP2 by touching the sharing button.

The software button SB12 is a software button configured to display a help screen (not shown). By touching the software button SB12, the operator OP can display, on the display part of the operator portable terminal device SP1, a screen displaying detailed information of the report screen SC3.

As described above, as illustrated in FIG. 2, the work machine 100 according to the embodiment of the present disclosure includes: the lower traveling body 1; the upper slewing body 3 that is slewably mounted on the lower traveling body 1; the attachment AT that is attached to the upper slewing body 3; the information acquisition device IAD configured to acquire the payload information that is information of the weight of the object loaded by the attachment AT on the bed of the delivery vehicle 200; and the communication device 50 that is a communication device configured to transmit the payload information to the portable terminal device (the operator portable terminal device SP1) configured to enable wireless communication with the delivery vehicle 200. The wireless communication between the delivery vehicle 200 and the operator portable terminal device SP1 is realized, for example, by the direct wireless communication. The “direct wireless communication” between the delivery vehicle 200 and the operator portable terminal device SP1 is wireless communication performed directly between the delivery vehicle 200 and the operator portable terminal device SP1 without a base station, such as a communication satellite, a ground base station, or the like. However, the “direct wireless communication” between the delivery vehicle 200 and the operator portable terminal device SP1 includes wireless communication performed via a repeater provided between the delivery vehicle 200 and the operator portable terminal device SP1. Also, in the illustrated example, the direct wireless communication between the portable terminal device (the operator portable terminal device SP1), the delivery vehicle 200, and the wireless communication device 50 is realized using Bluetooth (registered trademark). However, this direct wireless communication may be realized using another wireless communication protocol, such as Wi-Fi (registered trademark), ZigBee (registered trademark), Thread (registered trademark), Z-Wave (registered trademark), or the like.

This configuration provides the effect of reducing time and effort required for transmitting payload information from the operator OP of the work machine 100 to the driver DV of the delivery vehicle 200.

Also, the payload information may include the weight of the object loaded on the bed of the delivery vehicle 200, and the date and time the object is loaded on the bed of the delivery vehicle 200.

This configuration provides the effect that the operator OP and the driver DV who looked at the payload information can be reliably informed of the weight of the object loaded on the bed of the delivery vehicle 200, and the date and time the object is loaded on the bed of the delivery vehicle 200. In other words, this configuration provides the effect that the operator OP and the driver DV can quickly confirm the weight of the object loaded on the bed of the delivery vehicle 200, and the date and time the object is loaded on the bed of the delivery vehicle 200.

The payload information may include at least one of: the position of the work machine 100 that loads the object on the bed of the delivery vehicle 200; the type of the object loaded on the bed of the delivery vehicle 200; the name of the company to which the delivery vehicle 200 belongs; the name of the operator OP of the work machine 100 that loads the object on the bed of the delivery vehicle 200; or the information identification number.

This configuration provides the effect that the operator OP and the driver DV who looked at the payload information can be informed of more detailed information. In other words, this configuration provides the effect that the operator OP and the driver DV can quickly confirm more detailed information of the object loaded on the bed of the delivery vehicle 200.

Also, the wireless communication device 50 serving as the communication device may transmit the payload information to a server located at a remote place (a server installed in the management center 300).

This configuration provides the effect that the payload information can be managed in the management center 300. Therefore, this configuration provides the effect that people concerned, including the operator OP and the driver DV, can confirm the payload information at any timing from any location.

The payload information may include the information identification number. The payload information received by the delivery vehicle 200 and the payload information received by the server (the server installed in the management center 300) may be collated based on this information identification number.

This configuration provides the effect that, since consistency between the payload information received by the delivery vehicle 200 and the payload information received by the server (the server installed in the management center 300) can be confirmed by collating them, traceability of the object loaded on the bed of the delivery vehicle 200 can be improved.

Also, the portable terminal device (the operator portable terminal device SP1) is a multifunctional terminal, such as, for example, a smartphone carried by the operator OP of the work machine 100, and includes the display part configured to display various information. As illustrated in FIG. 8, the display part may be configured to display the history of the previous loading operations performed by the operator OP.

This configuration provides the effect of facilitating confirmation of the history of the previous loading operations performed by the operator OP.

As illustrated in FIG. 11, the display part of the portable terminal device (the operator portable terminal device SP1) may be configured to display an aggregate value in the previous loading operations performed by the operator OP.

This configuration provides the effect of facilitating confirmation of the aggregate value in the previous loading operations performed by the operator OP. Specifically, the operator OP can confirm the aggregate value in the previous loading operations only by installing the payload information management application in the operator portable terminal device SP1 (smartphone).

Also, the portable terminal device (the operator portable terminal device SP1) may be configured to wirelessly communicate with another portable terminal device (the driver portable terminal device SP2) carried by the driver DV of the delivery vehicle 200. The wireless communication may be realized by the direct wireless communication.

This configuration saves time and effort required for the operator OP to print a slip of the payload information and hand over the slip to the driver DV, thereby enabling improvement in efficiency of a loading operation.

Also, the portable terminal device (the operator portable terminal device SP1) may be configured to communicate with another portable terminal device (the driver portable terminal device SP2) without pairing.

This configuration saves time and effort required for establishing wireless communication between the operator portable terminal device SP1 and the driver portable terminal device SP2, thereby further facilitating transmission of the payload information from the operator OP to the driver DV. That is, the operator OP can transmit the electronic slip (E-ticket) to the driver portable terminal device SP2 only by touching the sharing button of the operator portable terminal device SP1 (smartphone) without performing a preliminary operation, such as pairing or the like. Also, the driver DV can receive the electronic slip (E-ticket) only by carrying the driver portable terminal device SP2 (smartphone) without performing a preliminary operation, such as pairing or the like.

Also, a portable terminal device for a work machine according to an embodiment of the present disclosure is a portable terminal device (the operator portable terminal device SP1) for being carried by the operator OP of the work machine 100. Note that the portable terminal device for a work machine of the present disclosure is an electronic circuit or circuitry (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit for specific applications. This portable terminal device for a work machine is configured to receive payload information transmitted from a communication device (the wireless communication device 50), generate an electronic slip (E-ticket) based on the received payload information, and transmit the electronic slip (E-ticket) to the delivery vehicle 200 through wireless communication. The wireless communication may be the direct wireless communication.

This configuration can save time and effort required for the operator OP to print a slip of the payload information, and time and effort required for handing over the slip to the driver DV, thereby enabling improvement in efficiency of a loading operation.

The embodiments of the present disclosure have been described above. However, the present disclosure is not limited to the above-described embodiments. Various modifications, substitutions, or the like are applicable to the above-described embodiments without departing from the scope of the present disclosure. Also, the features described with reference to the above-described embodiments may be appropriately combined as long as there is no technical contradiction.

What is claimed is:

1. A work machine, comprising:
a lower traveling body;
an upper slewing body that is slewably mounted on the lower traveling body;
an attachment that is attached to the upper slewing body;
an information acquisition device including circuitry configured to acquire payload information that is information of a weight of an object loaded by the attachment on a bed of a delivery vehicle; and
a communication device including circuitry configured to transmit the payload information to a portable terminal device configured to enable wireless communication with the delivery vehicle.

2. The work machine according to claim 1, wherein
the payload information includes:
the weight of the object loaded on the bed of the delivery vehicle; and
date and time the object is loaded on the bed of the delivery vehicle.

3. The work machine according to claim 2, wherein
the payload information includes at least one of:
a location of the work machine that loads the object on the bed of the delivery vehicle;
a type of the object loaded on the bed of the delivery vehicle;
a name of a company to which the delivery vehicle belongs;
a name of an operator of the work machine that loads the object on the bed of the delivery vehicle; or
an information identification number.

4. The work machine according to claim 1, wherein
the circuitry included in the communication device is configured to transmit the payload information to a server located at a remote place.

5. The work machine according to claim 4, wherein
the payload information includes an information identification number, and
the payload information received by the delivery vehicle and the payload information received by the server are collated based on the information identification number.

6. The work machine according to claim 1, wherein
the portable terminal device is a multifunctional terminal carried by an operator of the work machine, and includes a display part configured to display various information, and
the display part is configured to display a history of previous loading operations performed by the operator.

7. The work machine according to claim 1, wherein
the portable terminal device is a multifunctional terminal carried by an operator of the work machine, and includes a display part configured to display various information, and
the display part is configured to display an aggregate value in previous loading operations performed by the operator.

8. The work machine according to claim 1, wherein
the portable terminal device is configured to enable the wireless communication with another portable terminal device carried by a driver of the delivery vehicle.

9. The work machine according to claim 8, wherein
the portable terminal device and the another portable terminal device are configured to enable communication without pairing.

10. A portable terminal device for a work machine, the portable terminal device comprising:
circuitry configured to:
receive payload information transmitted from a communication device;
generate an electronic slip based on the received payload information; and
transmit the electronic slip to a delivery vehicle through wireless communication,
the portable terminal device is for being carried by an operator of the work machine, and
the work machine includes
a lower traveling body,
an upper slewing body that is slewably mounted on the lower traveling body,
an attachment that is attached to the upper slewing body,
an information acquisition device including circuitry configured to acquire the payload information that is information of a weight of an object loaded by the attachment on a bed of the delivery vehicle, and
the communication device including circuitry configured to transmit the payload information to an outside of the work machine.
